(19) United States
(12) Patent Application Publication
(10) Pub. No.: US 2026/0017532 A1
(43) Pub. Date: Jan. 15, 2026

(54) KNOWLEDGE DISTILLATION FOR EFFICIENT AND EFFECTIVE RELEVANCE SEARCH FOR ITEMS

(71) Applicant: Walmart Apollo, LLC, Bentonville, AR (US)

(72) Inventors: Nguyen Khanh Vo, Sunnyvale, CA (US); Hongwei Shang, Sunnyvale, CA (US); Zhen Yang, Santa Clara, CA (US); Juexin Lin, Redwood City, CA (US); Seyed Danial Mohseni Taheri, San Jose, CA (US); Changsung Kang, San Jose, CA (US)

(73) Assignee: Walmart Apollo, LLC, Bentonville, AR (US)

(21) Appl. No.: 18/771,626

(22) Filed: Jul. 12, 2024

(51) Int. Cl. G06N 3/096; G06N 3/045

(52) U.S. Cl. CPC G06N 3/096; G06N 3/045

(57) ABSTRACT

A system including one or more processors and one or more non-transitory computer-readable media storing computing instructions that, when executed on the one or more processors, cause the one or more processors to perform certain operations. The operations can include training a teacher machine-learning model to determine a level of relevance between a query and an item. The teacher machine-learning model can include a cross-encoder model comprising a large language model (LLM) component and a multilayer perceptron (MLP) component. The operations also can include training a student machine-learning model based on the teacher machine-learning model. The operations additionally can include receiving an input query from a user. The operations further can include determining relevance scores for a set of items based on item embeddings for the set of items and a query embedding for the input query. The operations additionally can include ranking the set of items based at least in part on the relevance scores. Other embodiments are described.

### TECHNICAL FIELD

This disclosure relates generally to models for search engines and relates more specifically to knowledge distillation for relevance search for items.

### BACKGROUND

Search engines are generally used to help users find results from search queries. Some search engines are used to search for items, such as e-commerce search engines. Many search engines for items use models that rely heavily on user engagement signals to understand query intent. For example, user engagement signals can indicate if the user who provided the search query clicked on an item, added the item to a cart, converted the item, etc. However, user engagement signals are limited for many items, so it can be difficult to rely on user engagement signals for determining the relevance of such items due to the lack of data.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for knowledge distillation for relevance search for items, according to an embodiment;

FIG. 4 illustrates flow chart for a framework for training a student model using a teacher model to provide knowledge distillation from the teacher model to the student model, according to an embodiment;

FIG. 5 illustrates a block diagram for a system for online serving of relevant search results based on offline indexing, according to an embodiment;

FIG. 6 shows equations used in training the teacher and student models;

FIG. 7 shows tables show performance results based on experimental testing of the teacher and student models and online serving; and

FIG. 8 illustrates a flow chart for a method of knowledge distillation for relevance search for items, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.05 second, 0.1 second, 0.02 second, 0.5 second, one second, or two seconds.

### DESCRIPTION OF EXAMPLES OF EMBODIMENTS

E-commerce search engines help users find what items (e.g., products) they are looking for, but in the realm of commercial e-commerce, search engines are often optimized to enhance user engagement and conversion rates, sometimes at the expense of relevance. Ensuring that search results align closely with user queries is beneficial for maintaining customer satisfaction and trust over time. Thanks to deep learning models' capabilities in semantic understanding, they have become the primary choice for relevance matching tasks. In real-time e-commerce scenarios, representation-based models are commonly used due to their efficiency. On the other hand, interaction-based models, while offering better effectiveness, are often time-consuming and challenging to deploy online. The emergence of the large language model (LLM) has marked a significant advancement in relevance search, presenting both value and complexity when applied to e-commerce domain. To address these challenges, the techniques described here can provide a novel framework to distill a highly effective interaction-based LLM into a low latency representation-based architecture (e.g., student model).

In many embodiments, the techniques described herein can improve effectiveness of representation-based models used in production while still meeting strict latency requirements of e-commerce search systems. The techniques can provide a novel knowledge distillation (KD) framework to distill an LLM (e.g., BERT (Bidirectional Encoder Representations from Transformers) base) into a representation-based student model (e.g., DistilBERT) offering improved effectiveness of the student model while maintaining efficiency of the representation-based models. In many embodiments, the techniques can involve first training a highly effective teacher model (e.g., LLM, which is used interchangeably herein with teacher model), followed by training the student model to mimic the LLM's behavior. In some embodiments, to train the teacher model, soft human labels that are converted from editorial feedback can be used to make the model aware of differences between a perfect match item, an item with a mismatched attribute (e.g., brand, color, style, etc.), and completely irrelevant items, instead of simply using binarized labels conventionally used. Using soft human labels can improve effectiveness of the teacher model. Attributes of items can be incorporated into the teacher model to enhance its performance. The student model can be trained to mimic the margin between a relevant item (d⁺) and an irrelevant item (d⁻) outputted by the teacher model. Soft targets outputted by the LLM can reduce noises and offer more informative knowledge about relevant differences between the two items. The teacher model/LLM can be served offline while the newly trained student model can be deployed into production.

In many embodiments, the techniques described herein can provide a novel framework of a representation-based student model distilled from an LLM, to generate a semantic matching feature for a reranking system in an e-commerce search engine. In many embodiments, the effectiveness of the teacher model can be improved by using soft human labels and items' attributes.

Various embodiments include a system including one or more processors and one or more non-transitory computer-readable media storing computing instructions that, when executed on the one or more processors, cause the one or more processors to perform certain operations. The operations can include training a teacher machine-learning model to determine a level of relevance between a query and an item. The teacher machine-learning model can include a cross-encoder model comprising a large language model (LLM) component and a multilayer perceptron (MLP) component. The operations also can include training a student machine-learning model based on the teacher machine-learning model. The operations additionally can include receiving an input query from a user. The operations further can include determining relevance scores for a set of items based on item embeddings for the set of items and a query embedding for the input query. The operations additionally can include ranking the set of items based at least in part on the relevance scores.

A number of embodiments include a method being implemented via execution of computing instructions configured to run at one or more processors. The method can include training a teacher machine-learning model to determine a level of relevance between a query and an item. The teacher machine-learning model can include a cross-encoder model comprising a large language model (LLM) component and a multilayer perceptron (MLP) component. The method also can include training a student machine-learning model based on the teacher machine-learning model. The method additionally can include receiving an input query from a user. The method further can include determining relevance scores for a set of items based on item embeddings for the set of items and a query embedding for the input query. The method additionally can include ranking the set of items based at least in part on the relevance scores.

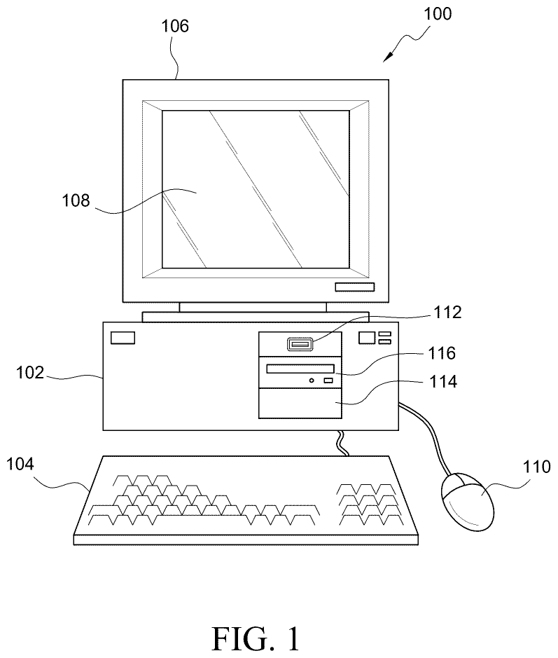

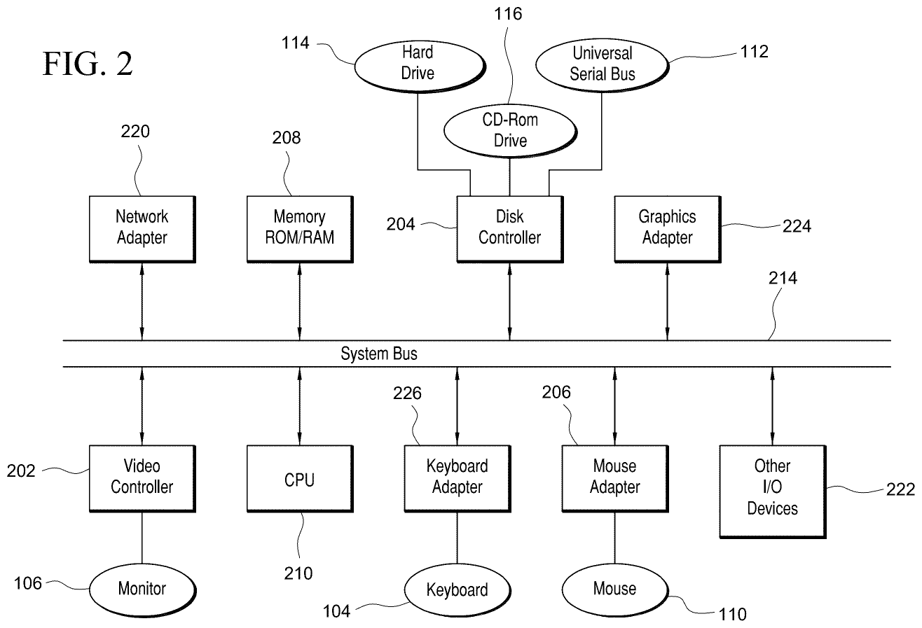

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random-access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general-purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

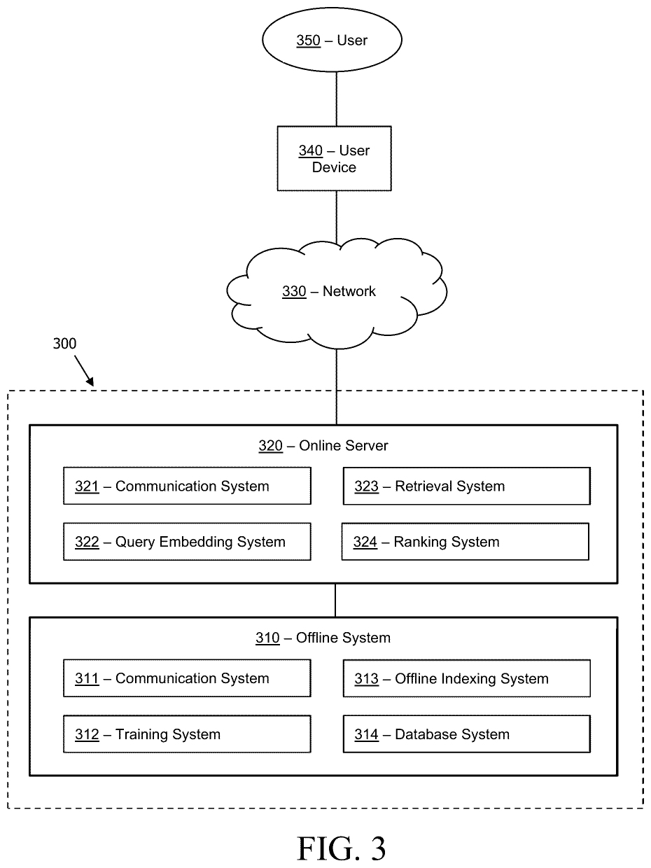

Turning ahead in the drawings, FIG. 3 illustrates a block diagram of a system 300 that can be employed for knowledge distillation for relevance search for items, according to an embodiment. System 300 is merely exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include an offline system 310 and/or an online system 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Offline system 310 and/or online system 320 can each be a computer system, such as computer system 100 (FIG. 1), as described above, and can each be a single computer, a single server, or a cluster or collection of computers or servers, or a cloud of computers or servers. In another embodiment, a single computer system can host offline system 310 and/or online system 320.

In some embodiments, online system 320 can be in data communication through a network 330 with one or more user devices, such as a user device 340. User device 340 can be part of system 300 or external to system 300. Network 330 can be the Internet or another suitable network. In some embodiments, user device 340 can be used by users, such as a user 350. In many embodiments, online system 320 can host one or more websites and/or mobile application servers. For example, online system 320 can be a web server that hosts a website, or provides a server that interfaces with an application (e.g., a mobile application), for user device 340, which can allow users (e.g., 350) to search for items (e.g., products), to add items to an electronic cart, and/or to purchase items, in addition to other suitable activities, or to interface with and/or configure offline system 310.

In some embodiments, an internal network that is not open to the public can be used for communications between offline system 310 and online system 320 within system 300. Accordingly, in some embodiments, offline system 310 (and/or the software used by such systems) can refer to a back end of system 300 operated by an operator and/or administrator of system 300, and online system 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, and/or (ii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Android™ operating system developed by the Open Handset Alliance, or (iii) the Windows Mobile™ operating system by Microsoft Corp. of Redmond, Washington, United States of America.

In many embodiments, offline system 310 and/or online system 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to offline system 310 and/or online system 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of offline system 310 and/or online system 320. In a similar manner, the processors and/or the non-transitory computer-readable media can be local and/or remote to each other.

Meanwhile, in many embodiments, offline system 310 and/or online system 320 also can be configured to communicate with one or more databases, such as a database system 314. The one or more databases can include an item database that contains information about items, products, or SKUs (stock keeping units), for example, among other information, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit, or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, offline system 310, online system 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, offline system 310 can include a communication system 311, a training system 312, an offline indexing system 313, and/or database system 314. In many embodiments, online system 320 can include a communication system 321, a query embedding system 322, a retrieval system 323, and/or a ranking system 324. In many embodiments, the systems of offline system 310 and/or online system 320 can be modules of computing instructions (e.g., software modules) stored at non-transitory computer readable media that operate on one or more processors. In other embodiments, the systems of offline system 310 and/or online system 320 can be implemented in hardware. Offline system 310 and/or online system 320 each can be a computer system, such as computer system 100 (FIG. 1), as described above, and can be a single computer, a single server, or a cluster or collection of computers or servers, or a cloud of computers or servers. In another embodiment, a single computer system can host offline system 310 and/or online system 320.

Various e-commerce platforms, such as Walmart, Ebay and Amazon, cater to millions of users daily with a vast array of products (items). Search engines help users find what they are looking for, but in the realm of commercial e-commerce, search engines typically rely heavily on user engagement signals to understand query intent and provide the best possible search results. Search queries from users are often segmented into head, torso and tail queries. Head and torso queries generally provide enough user engagement data to train machine learning models for retrieving and reranking relevant items. However, it is difficult to effectively retrieve and rerank the most relevant products for tail queries due to the lack of engagement data. The techniques described herein can advantageously help search results align closely with different types of queries from users, which can beneficially help maintain customer satisfaction and trust over time.

Conventional techniques of matching queries to items have limitations, particularly in bridging the vocabulary gap. To address this challenge, advanced neural network models have emerged as a powerful solution. These models, categorized into representation-based and interaction-based models, offer different approaches to text matching. Representation-based models encode queries and product titles into fixed-dimensional vectors separately, and then compute cosine similarity as a semantic matching feature for reranking, enabling efficient online computation, but potentially sacrificing detailed matching information.

On the other hand, interaction-based models excel at capturing fine-grained matching details by analyzing different parts of queries and products at a low level before making a final decision based on aggregated evidence. Although these models outperform representation-based ones in many text matching scenarios, they face challenges in terms of online deployment due to their inability to pre-compute embeddings offline and consider context effectively.

Recent advancements like LLMs (e.g., BERT, Llamma, Mistral, and Gemma) have revolutionized text matching tasks by combining the strengths of interaction-based and representation-based models. Their multilayer architecture based on Transformer allows for comprehensive interaction between queries and items at various semantic levels, addressing the shortcomings of previous models. Despite its effectiveness, LLM's computational intensity poses hurdles for practical online applications such as e-commerce search engines.

In many embodiments, the techniques described herein can improve effectiveness of representation-based models used in production while still meeting strict latency expectations of e-commerce search systems for tail queries segment. In many embodiments, a novel KD framework to distill an encoder-only LLM (e.g., BERT base) into a representation-based student model (e.g., DistilBERT), offering improved effectiveness of the student model while maintaining efficiency of the representation-based models. Many embodiments firstly train a highly effective teacher model, followed by training the student model to mimic the LLM's behavior. In many embodiments, to train the teacher model, soft human labels converted from editorial feedback can be used to make the model aware of differences between a perfect match item, an item with a mismatched attribute (e.g., brand, color, style, etc.), and completely irrelevant products, instead of simply using binarized labels conventionally used. In many embodiments, using soft human labels can improve effectiveness of the teacher model. In many embodiments, attributes of items also can be incorporated to the teacher model to enhance its performance. The student model can be trained to mimic the margin between a relevant item (d⁺) and an irrelevant item (d⁻) outputted by the teacher model. Soft targets outputted by the LLM can reduce noises and offer more informative knowledge about relevant differences between the two items. The teacher model/LLM can be served offline while the newly trained student model can be deployed into production.

Conventionally, the challenge of e-commerce search surpasses that of traditional web search owing to the shortness of user queries and the large number of potentially relevant items. In e-commerce, various signals are used to assess search result quality, including optimizing results based on user engagement metrics like click-through rate and conversion rate, best-selling products, and product result diversity. However, sparseness of user engagement data can limit model performance on queries without engagement (e.g., tail queries). Deep textual matching features based on deep neural-based models have been employed for retrieval and ranking, with enhancements such as incorporating different text representations and loss functions. Additionally, some models have integrated interaction features between user queries and a product graph to capture relationships among similar products in the ranking process and reinforcement learning for product search. The techniques described herein can advantageously provide an improvement over conventional approaches by developing a semantic matching feature based on a novel knowledge distillation framework, and can be used among other engagement signals for reranking in an e-commerce search engine.

Neural ranking models for text search can be categorized into two groups: representation-based models and interaction-based methods. Representation-based models generally seek to learn representations of a query and a document, and measure their similarity, while interaction-based methods generally capture relevant matching signals between a query and a document based on word/tokens interactions. Pretrained large language models, such as BERT can be leveraged. In the context of BERT-based relevance models, there are two common approaches. The first approach is independently learning representations of queries and items/products using dual BERT encoders. The second approach is to concatenate textual contents of a query-item pair and input the text into a BERT model, which demonstrate state-of-the-art performance on various benchmarks. The former approach is known as representation-based learning method while the later approach is an interaction-based approach. The e-commerce relevance task, akin to text matching, poses challenges for commercial search engines due to high traffic and low latency expectations. This challenge makes deploying interaction-based LLMs online a significant hurdle. To address this issue, the techniques described herein involve distilling the interaction-based LLM (e.g., BERT base) into a representation-based architecture (e.g., DistilBERT), which can beneficially enhance ranking effectiveness while maintaining efficiency of online search systems.

Online recommendation/search systems often involve strict latency expectations in real-time, which hinders the deployment of LLMs (e.g., BERT, LLamma, GPT). Knowledge Distillation (KD) provides a compression technique to compress these LLM models into smaller ones, which can enable an online system to leverage sophisticated models like BERT effectively. KD can involves training a high-performance teacher model initially, followed by training a simpler student network to replicate the teacher's behavior. Knowledge distillation methods generally fall into three groups: (1) response-based learning, (2) representation-based methods and (3) relation-based knowledge. The techniques described herein can be viewed as a response-based technique, because the student model can be optimized to learn from the soft targets generated by a large language model (LLM), which are more informative and less noisy. In many embodiments, the teacher model can be trained with items' attributes and/or soft ratings converted from editorial feedback, which can beneficially increase effectiveness.

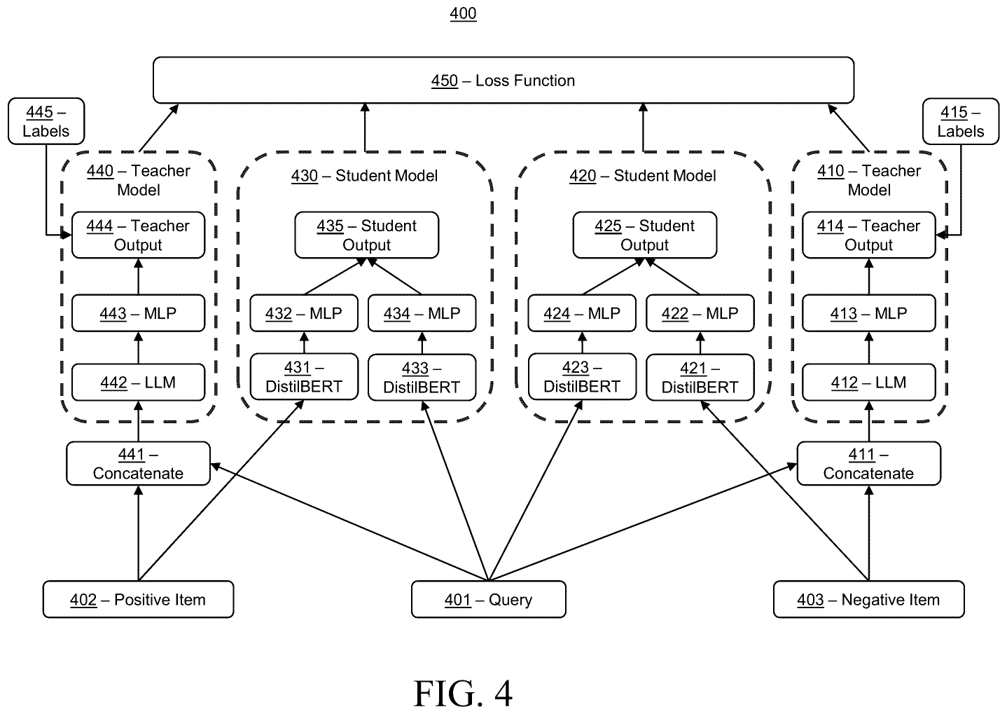

Turning ahead in the drawings, FIG. 4 illustrates flow chart for a framework 400 for training a student model using a teacher model to provide knowledge distillation from the teacher model to the student model, according to an embodiment. Framework 400 is merely exemplary and is not limited to the embodiments presented herein. Framework 400 can be employed in many different embodiments or examples not specifically depicted or described herein. In some embodiments, the procedures, the processes, and/or the activities of framework 400 can be performed in the order presented. In other embodiments, the procedures, the processes, and/or the activities of framework 400 can be performed in any suitable order. In still other embodiments, one or more of the procedures, the processes, and/or the activities of framework 400 can be combined or skipped. In many embodiments, framework 400 can be implemented using training system 312 (FIG. 3).

As shown in FIG. 4, framework 400 of training a student model using a teacher model can involve inputs of a query 401, a positive item 402 (d⁺), and a negative item 403 (d⁻), in which positive item 401 (d⁺) is more relevant to query 401 than negative item 403 (d⁻). In many embodiments, framework 400 can address the following problem formulation: Given a query q and an item d, where every item d has title and textual attributes such as product type, brand, color, and gender, train a teacher model t(q, d)∈ [symbol] and a student model s(q, d)∈ [symbol] . These two functions can determine the relevancy of q and d. After training the LLM, the student model can be trained by learning from soft-targets outputted by the LLM in the KD process. Framework 400 can include a teacher model 410 and a student model 420. In many embodiments, teacher model 410 can include an interaction-based LLM (e.g., BERT base), and/or the student model can include a representation-based model (e.g., DistilBERT). As shown in FIG. 4, teacher model 410 and student model 420 can be applied to query 401 and negative item 403, and can be mirrored as student model 430 and teacher model 440 to be applied to query 401 and positive item 402.

For each query-item pair (q, d), a teacher model (e.g., 410, 440) can be utilized. Teacher model 410 can include an LLM 412 (e.g., BERT base) as encoder. In many embodiments, framework 400 can include an activity 411 of concatenating the inputs to the teacher model. For example, query 401 (q) and negative item 403 (d⁻) can be textually concatenated. For example, in BERT, the input can be:

[CLS] query tokens [SEP] item tokens

where [CLS] is a token in BERT representing the full text, query tokens are the words of the query, [SEP] is a token representing a separator, and item tokens are the information about the item.

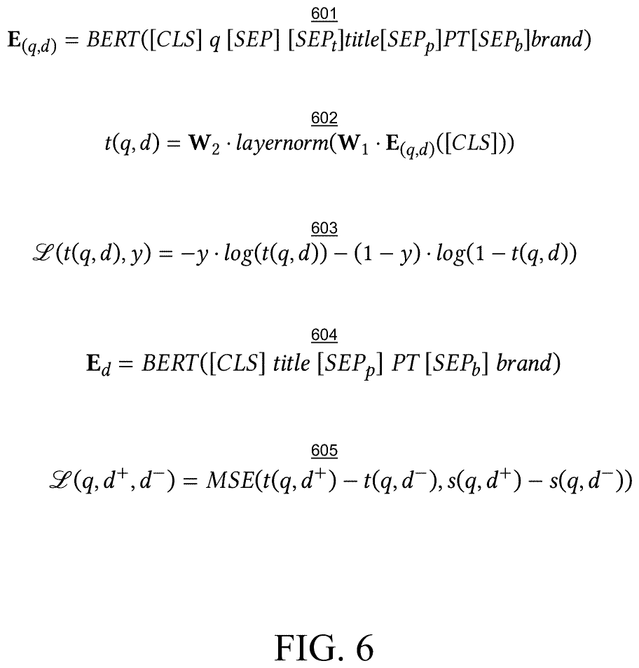

In some embodiments, the item title may not contain sufficient information to determine relevancy of the query and the item, so the item's attributes (e.g., product type (PT), brand, etc.) can be used if they are available. The title and each of the attributes can have unique separator tokens as shown in equation 601 (FIG. 6). The hidden state E_{(q,d)} ([CLS]) of [CLS] token can be taken as the query-item pair representation. Using items' attributes, such as product types, brands, colors, and genders to enhance effectiveness of an interaction-based LLM can provide a novelty that advantageously improves the relevance determination.

To compute relevance score t(q, d) of the teacher model, input E_{(q, d)}([CLS]) can be input into MLP layers 413 of teacher model 410 as shown in equation 602 (FIG. 6), where W₁∈ [symbol] ^{768×d}, W₂∈ [symbol] ^{d×1}, and layernorm is layer normalization used to normalize the distributions of intermediate layers. The output of LLM component 412 can be a 768-dimension vector (or vector of another suitable dimension), which represents the query-item pair. This 768-dimension vector output from LLM component 412 can be input into the MLP component 413. MLP component can output a real number, which can represent a prediction of the level of relevance. This number representing the prediction of the level of relevance can be converted using a sigmoid function to the 0-1 scale (e.g., 0, 0.5, 1), which can be a teacher output 414 of teacher model 410.

In many embodiments, biases can be removed to avoid clutter. In many embodiments, for training, for each query-item pair (q, d), its rating can be “Excellent” (e.g., a perfect match), “Good” (e.g., an item with a mismatched attribute, e.g., brand, color, style, etc.), “Okay”, “Bad” (e.g., irrelevant items), etc. For example, a human can provide a rating of 0, 1, 2, 3, or 4, where 4 is 0 and 0 is completely irrelevant. In some embodiments, excellent/good items can be converted to be labeled as 1s and the rest as 0s. However, such approach can be suboptimal, as excellent items and good items are viewed as equal. To help LLM 412 distinguish these items, editorial feedback can be converted into soft human labels by labelling an excellent item (editor label of 4) as 1, a good item (editor label of 3) as 0.5, and other items (editor labels of 0, 1, or 2) as 0. The converted human labels can be labels 415, which can be used in cross-entropy loss to train LLM 412 as shown in equation 603 (FIG. 6), where y∈{0, 1, 0.5} converted from original editorial feedback.

In many embodiments, student model 420 can include a DistilBERT component as an encoder, which identical towers (Siamese network). For each query-item pair (q, d), the query can be input to the DistilBERT as follows:

E_{q}=DistilBERT([CLS]q[SEP])

and use hidden state E_{q}([CLS]) of the [CLS] token as the query's representation. For the item, its title and its available attributes can be concatenated, with the concatenated text input into DistilBERT as shown in equation 604 (FIG. 6). The hidden state E_{d}([CLS]) of the [CLS] token can be used as the item's representation. The scoring function can be t(q, d)=cosine_sim(E_{q} ([CLS]), E_{d} ([CLS])), where cosine_sim is a cosine similarity measure. As shown in FIG. 4, negative item 403 can be input into a DistilBERT component 421, which can output an item representation, such as a 768-dimension vector (or vector of another suitable dimension). This item representation can be input into an MLP component 422, which can output an item embedding, which can be a vector having a smaller dimension than the item representation, such as a 512-dimension vector or a 256-dimension vector (or vector of another suitable dimension). Similarly, query 401 can be input into a DistilBERT component 423, which can output a query representation, such as a 768-dimension vector (or vector of another suitable dimension). DistilBERT component 421 and DistilBERT component 423 can have shared parameters, as a Siamese network. This query representation can be input into an MLP component 424, which can output a query embedding, which can be a vector having a smaller dimension than the query representation, such as a 512-dimension vector or a 256-dimension vector (or vector of another suitable dimension). The cosine similarity measure can then be used to determine a student output 425 of student model 420.

To train student model 420, a loss function 450 can be used. In many embodiments, loss function can use a margin MSE (mean squared error) loss to help the student model mimic the LLM's predicted margin. In many embodiments, a query q, a positive item, d⁺, and a negative item d′ can be used, as shown in FIG. 4. Framework 400 can include a student model 430 used for query 401 and positive item 402. Student model 430 can be student model 420, except that student model 430 uses positive item 402 as input instead of negative item 403, in order to generate a student output 435 for the relevance of positive item 402 to query 401 instead of student output 425 for the relevance of negative item 403 to query 401. For example, positive item 402 can be input into a DistilBERT component 431 (which can be identical to DistilBERT component 421), which can output an item representation, such as a 768-dimension vector (or vector of another suitable dimension). This item representation can be input into an MLP component 432 (which can be identical to MLP component 422), which can output an item embedding, which can be a vector having a smaller dimension than the item representation, such as a 512-dimension vector or a 256-dimension vector (or vector of another suitable dimension). Similarly, query 401 can be input into a DistilBERT component 433 (which can be identical to DistilBERT component 423), which can output a query representation, such as a 768-dimension vector (or vector of another suitable dimension). DistilBERT component 431 and DistilBERT component 433 can have shared parameters, as a Siamese network. This query representation can be input into an MLP component 434 (which can be identical to MLP component 424), which can output a query embedding, which can be a vector having a smaller dimension than the query representation, such as a 512-dimension vector or a 256-dimension vector (or vector of another suitable dimension). The cosine similarity measure can then be used to determine student output 435 of student model 430.

Similarly, teacher model 440 can be teacher model 410, except that teacher model 440 uses positive item 402 as input instead of negative item 403, in order to generate a teacher output 444 for the relevance of positive item 402 to query 401 instead of teacher output 414 for the relevance of negative item 403 to query 401. For example, positive item 402 can be input with query 401 into an activity 441 of concatenating, which can be similar or identical to activity 411 of concatenating. Then, the concatenated tokens can be fed into an LLM component 442 (which can be identical to LLM component 412) to generate a 768-dimension vector (or vector of another suitable dimension), which can be input into an MLP component 443 (which can be identical to MLP component 443), to generate a teacher prediction, which can be converted using a sigmoid function, as described above, to generate teacher output 444. In the context of training, teacher model 440 can be trained using labels 445, which can be similar or identical to labels 415 described above.

In many embodiments, teacher output 414 (e.g., t(q, d⁻)) and teacher output 444 (e.g., t(q, d⁺)) can be viewed as soft targets, and student output 425 (e.g., s(q, d⁻)), and student output 435 (e.g., s(q, d⁺)) can be computed. Teacher output 414 (e.g., t(q, d⁻)), teacher output 444 (e.g., t(q, d⁺)), student output 425 (e.g., s(q, d⁻)), and student output 435 (e.g., s(q, d⁺)) can be input into loss function 450 to determine the margin MSE loss for query 401 (q) between positive item 402 (d⁺) and negative item (d⁻), such as using loss function in equation 605 (FIG. 6), which can be a the margin MSE loss function. Loss function 450 can be used on training data (using many examples of queries 401, positive items 402, and negative items 403, with labels (e.g., 415, 445)) to train student model 420/430 based on the teacher model 410/440 so that the margin between the student outputs (435 and 425) approaches the margin between the teacher outputs (444 and 414). Once trained, the student model 420/430 can be deployed for online use.

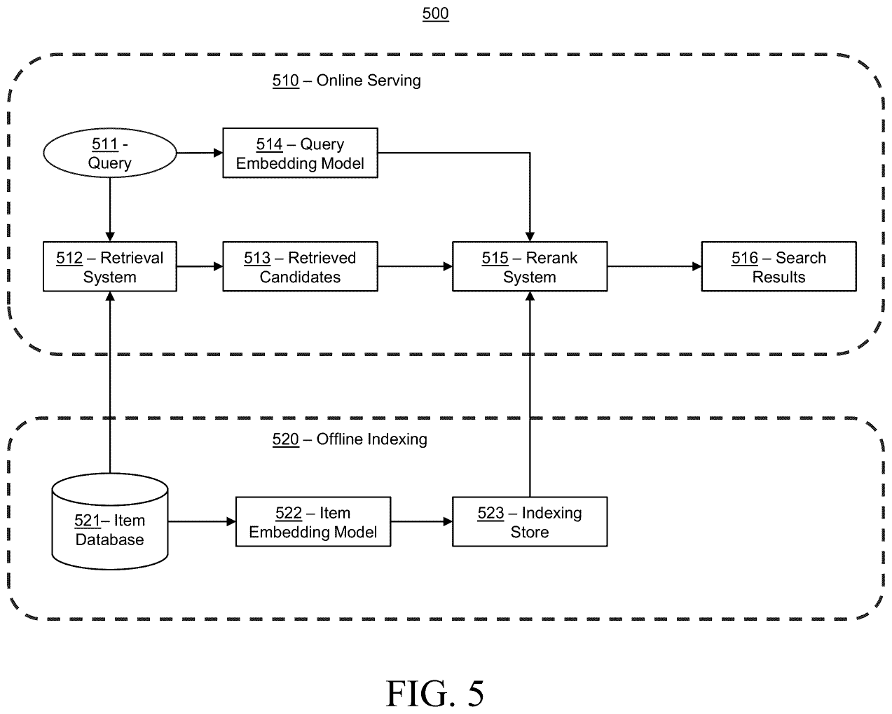

Turning ahead in the drawings, FIG. 5 illustrates a block diagram for a system 500 for online serving of relevant search results based on offline indexing, according to an embodiment. System 500 is merely exemplary, and embodiments of the system are not limited to the embodiments presented herein. The system can be employed in many different embodiments or examples not specifically depicted or described herein. In some embodiments, certain elements, modules, or systems of system 500 can perform various procedures, processes, and/or activities. In other embodiments, the procedures, processes, and/or activities can be performed by other suitable elements, modules, or systems of system 500.

After training student model 420/430 (FIG. 4), it can be deployed into production, such as in the manner shown in FIG. 5. In many embodiments, such as shown in FIG. 5, system 500 can include an offline indexing component 520 and an online serving component 510. In many embodiments the item embeddings for all the items can be indexed with offline indexing component 520. For every query 511 (q), online serving component 510 can generate q's embedding online. From top-k retrieved candidates 513 of a retrieval system, a semantic matching feature can be computed based on the query's embedding and the retrieved items' embeddings. The semantic matching feature can be used among other ranking features by a tree-based model to rank documents and return search results. In some embodiments, the features used in a rerank system 515 can be organized into three groups: (1) query features (e.g., query's attributes, length, etc.), (2) item features (e.g., item attributes, user reviews, ratings, etc.) and/or (3) query-item features (e.g., query-item engagement). The semantic matching feature is a query-item feature.

In many embodiments, offline indexing component 520 can include an item database 521, an item embedding model 522, and/or an indexing store 523. Item database 521 can be similar or identical to database system 314 (FIG. 3). Item database 521 can include information about items, such as title, product type, brand, etc. In many embodiments, item embedding model 522 can be similar or identical to offline indexing system 313 (FIG. 3), which can be similar or identical to one of the towers of student model 420/430 (FIG. 4), such as DistilBERT 421/431 (FIG. 4) and MLP 422/432 (FIG. 4), which can input an item and generate an item embedding. The item embeddings for the items in item database 521 can be precomputed offline using item embedding model 522 and stored in indexing store 523. Indexing store 523 can be stored in a database, such as database system 314 (FIG. 3).

In many embodiments, online serving component 510 can process queries, such as query 511, in real-time. In many embodiments, online serving component 510 can include a retrieval system 512, which can be similar or identical to retrieval system 323 (FIG. 3). In many embodiments, retrieval system 512 can retrieve items (e.g., retrieved candidates 513) from item database 521 that are candidate items for being relevant to the query. In many embodiments, retrieval system 512 can use conventional approaches for determining the candidate items, such as conventional search engine approaches. In some embodiments, retrieved candidates 513 can be a subset of the items in item database 521. For example, there can be 32 items, 64 items, 128 items, 256 items, or 512 items, as examples. In many embodiments, these candidate items are ranked, such as through conventional techniques.

In many embodiments, online serving component 510 can include a query embedding model 514. In many embodiments, query embedding model 514 can be similar or identical to query embedding system 322 (FIG. 3), which can be similar or identical to one of the towers of student model 420/430 (FIG. 4), such as DistilBERT 423/433 (FIG. 4) and MLP 424/434 (FIG. 4), which can input a query and generate a query embedding. In many embodiments, once a query (e.g., 511) is received, query embedding model 514 can generate a query embedding, which in some embodiments can be performed in parallel with determining retrieved candidates 513.

In many embodiments, online serving component 510 can include rerank system 515, which can be similar or identical to ranking system 324 (FIG. 3). In many embodiments, rerank system 515 can input the query embedding for query 511 generated by query embedding model, and input retrieved candidates 513 to determine which item embeddings to pull from indexing store 523. Specifically, rerank system 515 can pull the precomputed item embeddings for the items that match retrieved candidates 513. In many embodiments, rerank system can use the query embedding and the respective item embedding for each candidate item of retrieved candidates 513 to determine a respective relevance score for the candidate item. For example, the cosine similar measure can be used on the query embedding and the item embedding to determine the relevance score for the item, which can be a query-item relevance that is used as a semantic matching feature for the item. In many embodiments, these relevance scores for the candidate items can then be used to rerank the candidate items. For example, the relevance score can be a semantic matching feature that is used in a rerank algorithm. In some embodiments, a tree-based machine-learning model, e.g., XGBoost, can be used to determine how to re-rank the candidate items, and the relevance score can be a feature in the tree-based machine learning model. In other embodiments, other suitable approaches can be used to reranking the items. The output of rerank system 515 can be the items in a reranked order, which can be used as search results 516. In many embodiments, search results 516 can be determined in real-time after query 511 is received.

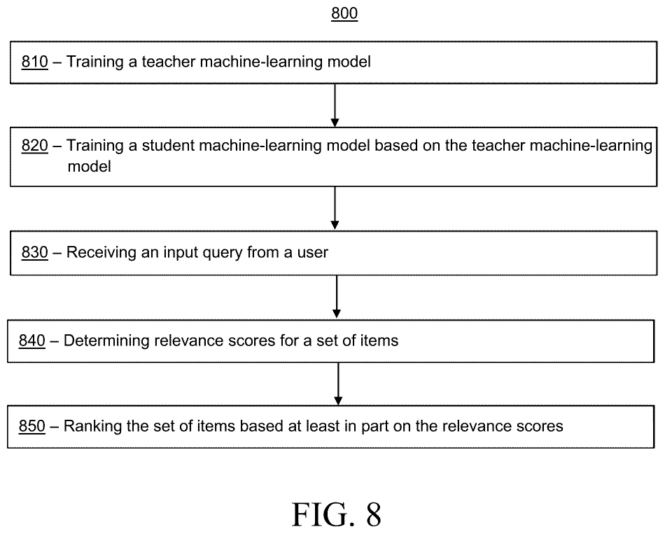

Jumping ahead in the drawings, FIG. 8 illustrates a flow chart for a method 800 of knowledge distillation for relevance search for items, according to another embodiment. Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of method 800 can be performed in any suitable order. In still other embodiments, one or more of the procedures, the processes, and/or the activities of method 800 can be combined or skipped.

In many embodiments, system 300 (FIG. 3), offline system 310 (FIG. 3), and/or online system 320 (FIG. 3) can be suitable to perform method 800 and/or one or more of the activities of method 800. In these or other embodiments, one or more of the activities of method 800 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

In some embodiments, method 800 and other activities in method 800 can include using a distributed network including distributed memory architecture to perform the associated activity. This distributed architecture can reduce the impact on the network and system resources to reduce congestion in bottlenecks while still allowing data to be accessible from a central location.

Referring to FIG. 8, method 800 can include an activity 810 of training a teacher machine-learning model to determine a level of relevance between a query and an item. The teacher machine-learning model can be similar or identical to teacher model 410/440 (FIG. 4). In many embodiments, the teacher machine-learning model can include a cross-encoder model comprising a large language model (LLM) component and a multilayer perceptron (MLP) component. The LLM component can be similar or identical to LLM 412/442 (FIG. 4). The MLP component can be similar or identical to MLP 413/443 (FIG. 4). In many embodiments, activity 810 of training the teacher machine-learning model can be performed using training system 312 (FIG. 3). In a number of embodiments, the level of relevance that is output from the teacher machine-learning model can include a soft label, such as 0.5, among 0 and 1. In several embodiments, an output of the LLM component can be used as an input to the MLP component of the teacher machine-learning model. In various embodiments, the teacher machine-learning model can be trained using a loss function for cross-entropy loss to train parameters for both the LLM component and the MLP component.

In a number of embodiments, method 800 also can include an activity 820 of training a student machine-learning model based on the teacher machine-learning model. The student machine-learning model can be similar or identical to student model 420/430 (FIG. 4). In many embodiments, the student machine-learning model can include a dual encoder comprising a first representation model for a query and a second representation model for an item. In many embodiments, the first representation model and the second representation model of the student machine-learning model can use shared parameters. In many embodiments, each of the first representation model and the second representation model of the student machine-learning model can include a respective DistilBERT component and a respective MLP component. For example, the first representation model can be similar or identical to DistilBERT component 421 and MLP 422 (FIG. 4), and the second representation model can be similar or identical to DistilBERT 423 and MLP 424 (FIG. 4).

In many embodiments, the student machine-learning model can use a cosine similarity measure to determine a relevance output based on a first embedding that is output from the respective MLP component of the first representation model and a second embedding that is output from the respective MLP component of the second representation model. For example, the first embedding can be an item embedding, and the second embedding can be a query embedding.

In many embodiments, the student machine-learning model can be trained based on the teacher machine-learning model using a margin mean squared error (MSE) loss function for (i) a first difference between teacher outputs of the teacher machine-learning model for a positive item and a negative item for a first query, and (ii) a second difference between student outputs of the student machine-learning model for the positive item and the negative item for the first query. The margin MSE loss function can be similar or identical to loss function 450 (FIG. 4). The positive item can be similar or identical to positive item 402 (FIG. 4). The negative item can be similar or identical to negative item 403 (FIG. 4). The first query can be similar or identical to query 401 (FIG. 4). The teacher outputs can be similar or identical to teacher outputs 414, 444 (FIG. 4). The student outputs can be similar to student outputs 425, 435 (FIG. 4). In many embodiments, activity 820 of training the student machine-learning model can be performed using training system 312 (FIG. 3).

In several embodiments, method 800 additionally can include an activity 830 of receiving an input query from a user. In many embodiments, activity 830 can be performed by communication system 321 (FIG. 3). Input query can be similar or identical to query 511 (FIG. 5).

In a number of embodiments, method 800 further can include an activity 840 of determining relevance scores for a set of items based on item embeddings for the set of items and a query embedding for the input query. In many embodiments, activity 830 can be performed by ranking system 324 (FIG. 3) and/or rerank system 515 (FIG. 5). In many embodiments, the item embeddings can be precomputed before receiving the input query from the user, such as by offline indexing system 313 (FIG. 3) and/or item embedding model 522 (FIG. 5). In a number of embodiments, the query embedding for the input query can be computed in real-time after receiving the input query, such as by query embedding system 322 (FIG. 3) and/or query embedding model 514 (FIG. 5).

In several embodiments, method 800 additionally can include an activity 850 of ranking the set of items based at least in part on the relevance scores. In many embodiments, activity 830 can be performed by ranking system 324 (FIG. 3) and/or rerank system 515 (FIG. 5). In many embodiments, ranking the set of items can be a reranking of the set of items, such as described above.

In many embodiments, the techniques described herein can provide a practical application and several technological improvements. In some embodiments, the techniques described herein can provide for a new way of training a machine-learning model to provide improved relevance in search results. The techniques described herein can provide a significant improvement over conventional approaches that either involve high latency or lower relevance in low latency approaches.

In a number of embodiments, the techniques described herein can solve a technical problem that arises only within the realm of computer networks, as search queries for online search engines do not exist outside the realm of computer networks. Moreover, the techniques described herein can solve a technical problem that cannot be solved outside the context of computer networks. Specifically, the techniques described herein cannot be used outside the context of computer networks, in view of a lack of data, the lack of search result pages, and the inability to perform machine learning models without a computer.

The models described herein were evaluated to determine if they provided an improved efficiency and/or effectiveness, and the results of the evaluation indicate that there are performance improvements to using these approach of these new teacher and student models. For the performance evaluation, to train text matching models, human editorial labels were used, which may have smaller size but are more reliable to capture textual relevancy between a query and an item, to train the models. Over the years, human editorial evaluation data is generated by manually assessing the top-ranked items for a set of sampled queries by a control ranking model and a variant model. The queries are sampled based on search traffic. Totally, 700K queries were collected in an in-house dataset, in which each query has a list of ˜10-20 items with human editorial ratings. Click-search logs were not used to train these models. The original ratings were converted into soft human labels, as described above. For each query-item pair (q, d), its rating can be Excellent, Good, Okay, Bad, etc., as described above. Not all attributes hold equal importance. To further increase the number of query-item pairs, some hard negative items were included for each of the queries. While the addition of these hard negatives did not lead to significant relevance gains, including hard negatives resulted in the model yielding more consistent results than using random negative items.

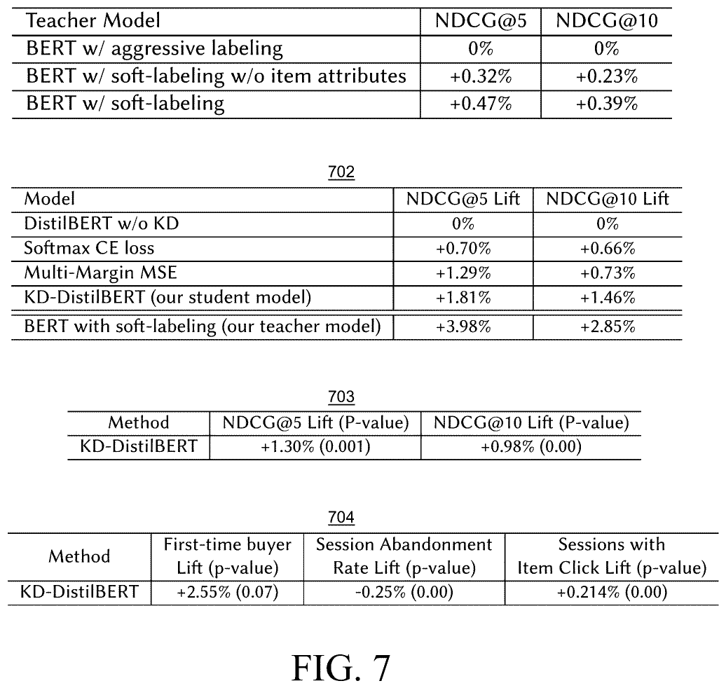

Multiple methods to train the teacher models were explored, with an emphasis on the labeling strategy and the loss function. Aggressive labeling was employed, in which excellent items are labeled as positive 1, while all others are labeled as negative 0. The performance results analysis showed that subject mismatch accounts for 20% of irrelevant search results, thus distinguishing between good and irrelevant items can be beneficial for improving the relevance of top items. In table 701 (FIG. 7), the performance of the interaction-based teacher model trained with aggressive labeling is compared to the interaction-based teacher model trained with soft-labeling, where label is 1 for excellent match, 0.5 for good match, 0 for irrelevant match. A relative gain of +0.47% in NDCG5 with the soft-labeling approach is observed. Additionally, other methods for distinguishing between good items and irrelevant items were tested, including multi-class classification (MCCE) and Multivariate Ordinal Regression (Ordinal), and these approaches did not result in an NDCG improvement. For knowledge distilling, using soft-labeling also is easier for knowledge distillation compared against MCCE and Ordinal. Soft-labeling approach generate a single logit output, simplifying the knowledge distillation process compared to the two-output approach of MCCE and Ordinal. Based on above, the soft-labeling method was used as the teacher model for training the student model.

Experiments were also conducted including and excluding item attributes in the model input. The results indicate that including item attributes improves the NDCG metrics, as shown in table 701 (FIG. 7).

The student model described herein (KD-DistilBERT) was trained with margin MSE loss with KD response-based method. Performance of the best-performing teacher model, described, above, was also included. As shown in table 702 (FIG. 7), all KD-based methods outperform distilBERT training without knowledge distillation significantly with p-value<0.001 by using t-test, indicating the effectiveness of using soft-targets outputted by the teacher model. The student model described herein (KD-DistilBERT) performs best among the KD-based methods. The teacher model described herein outperforms all student models with large gaps. Note that, all student models have the same model architecture (DistilBERT) for fair comparisons.

In terms of latency, the teacher model is much slower than the student model. In runtime, given a query (q, d), the teacher model makes an inference for a concatenation of the query and the item, while for the student model, the item's embedding can be precomputed offline, and as the content of the query is short, online inference for the query's representation is fast. Therefore, the student model can be advantageous for online applications. As the student model has same architecture with the existing production model, the student model does not incur any additional latency.

Online performance of the student model (KD-DistilBERT) was assessed by human evaluators who compared the top-10 results from the student model with an e-commerce production system which already has a semantic matching feature by using siamese DistilBERT model. Because DistilBERT is still the encoder, this framework does not incur any additional latency. Queries were randomly sampled from search traffic at the e-commerce system. As seen in table 703 (FIG. 7), the student model outperforms the production system significantly on relevancy metrics (NDCG@5 and NDCG@10). Reported results were statistically significance t-test. A/B test was also conducted to compare engagement metrics of the framework described herein and the production system. As shown in table 704 (FIG. 7), the student model increases first-time buyer by 2.55%, reduces abandonment search sessions by 0.25%, and increases the number of sessions with click by 0.214%.

The techniques described herein are a novel knowledge distillation framework consisting of an LLM as the teacher model and a DistilBERT as the student model. The effectiveness of LLM is shown to be improved by using soft human labels and items' attributes. The student model described herein (KD-DistilBERT) outperformed baselines in offline and online experiments while maintaining efficiency of the existing production system.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although knowledge distillation for relevance search for items has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-8 may be modified, and that the foregoing discussion of certain of these embodiments does not necessarily represent a complete description of all possible embodiments. For example, one or more of the procedures, processes, or activities of FIGS. 4-5 and 8 may include different procedures, processes, and/or activities and be performed by many different modules, in many different orders, and/or one or more of the procedures, processes, or activities of FIGS. 4-5 and 8 may include one or more of the procedures, processes, or activities of another different one of FIGS. 4-5 and 8. As another example, the systems within system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform operations comprising:
training a teacher machine-learning model to determine a level of relevance between a query and an item, wherein the teacher machine-learning model comprises a cross-encoder model comprising a large language model (LLM) component and a multilayer perceptron (MLP) component;
training a student machine-learning model based on the teacher machine-learning model;
receiving an input query from a user;
determining relevance scores for a set of items based on item embeddings for the set of items and a query embedding for the input query; and
ranking the set of items based at least in part on the relevance scores.

2. The system of claim 1, wherein the level of relevance that is output from the teacher machine-learning model comprises a soft label.

3. The system of claim 1, wherein an output of the LLM component is used as an input to the MLP component of the teacher machine-learning model.

4. The system of claim 1, wherein the teacher machine-learning model is trained using a loss function for cross-entropy loss to train parameters for both the LLM component and the MLP component.

5. The system of claim 1, wherein:
the student machine-learning model comprises a dual encoder comprising a first representation model for a query and a second representation model for an item; and
the first representation model and the second representation model of the student machine-learning model use shared parameters.

6. The system of claim 5, wherein each of the first representation model and the second representation model of the student machine-learning model comprises a respective DistilBERT component and a respective MLP component.

7. The system of claim 6, wherein the student machine-learning model uses a cosine similarity measure to determine a relevance output based on a first embedding that is output from the respective MLP component of the first representation model and a second embedding that is output from the respective MLP component of the second representation model.

8. The system of claim 1, wherein the student machine-learning model is trained based on the teacher machine-learning model using a margin mean squared error (MSE) loss function for (i) a first difference between teacher outputs of the teacher machine-learning model for a positive item and a negative item for a first query, and (ii) a second difference between student outputs of the student machine-learning model for the positive item and the negative item for the first query.

9. The system of claim 1, wherein the item embeddings are precomputed before receiving the input query from the user.

10. The system of claim 1, wherein the query embedding for the input query is computed in real-time after receiving the input query.

11. A method implemented via execution of computing instructions configured to run at one or more processors, the method comprising:
training a teacher machine-learning model to determine a level of relevance between a query and an item, wherein the teacher machine-learning model comprises a cross-encoder model comprising a large language model (LLM) component and a multilayer perceptron (MLP) component;
training a student machine-learning model based on the teacher machine-learning model;
receiving an input query from a user;
determining relevance scores for a set of items based on item embeddings for the set of items and a query embedding for the input query; and
ranking the set of items based at least in part on the relevance scores.

12. The method of claim 11, wherein the level of relevance that is output from the teacher machine-learning model comprises a soft label.

13. The method of claim 11, wherein an output of the LLM component is used as an input to the MLP component of the teacher machine-learning model.

14. The method of claim 11, wherein the teacher machine-learning model is trained using a loss function for cross-entropy loss to train parameters for both the LLM component and the MLP component.

15. The method of claim 11, wherein:
the student machine-learning model comprises a dual encoder comprising a first representation model for a query and a second representation model for an item; and
the first representation model and the second representation model of the student machine-learning model use shared parameters.

16. The method of claim 15, wherein each of the first representation model and the second representation model of the student machine-learning model comprises a respective DistilBERT component and a respective MLP component.

17. The method of claim 16, wherein the student machine-learning model uses a cosine similarity measure to determine a relevance output based on a first embedding that is output from the respective MLP component of the first representation model and a second embedding that is output from the respective MLP component of the second representation model.

18. The method of claim 11, wherein the student machine-learning model is trained based on the teacher machine-learning model using a margin mean squared error (MSE) loss function for (i) a first difference between teacher outputs of the teacher machine-learning model for a positive item and a negative item for a first query, and (ii) a second difference between student outputs of the student machine-learning model for the positive item and the negative item for the first query.

19. The method of claim 11, wherein the item embeddings are precomputed before receiving the input query from the user.

20. The method of claim 11, wherein the query embedding for the input query is computed in real-time after receiving the input query.
